(19) United States
(12) Patent Application Publication
(10) Pub. No.: US 2022/0151229 A1
(43) Pub. Date: May 19, 2022

(54) Synergistic Herbicidal Combinations

(71) Applicant: Clariant International Ltd., Muttenz (CH)

(72) Inventors: Peter BAUR, Schondorf (DE); Luciana BODELON, Frankfurt am Main (DE); Javier CAMPOS CUEVAS, Bad Soden (DE); Martin BAUER, Eppstein (DE); Stephanie GIESSLER-GEISS, Frankfurt am Main (DE); Felix HÖVELMANN, Mühldorf (DE)

(73) Assignee: Clariant International Ltd., Muttenz (CH)

(21) Appl. No.: 17/433,560

(22) PCT Filed: Feb. 14, 2020
(86) PCT No.: PCT/EP2020/053894

§ 371 Date: Aug. 24, 2021

(30) Foreign Application Priority Data
Feb. 25, 2019 (EP) 19159071.0

(51) Int. Cl. A01N 37/12; A01N 47/36; A01P 13/00

(52) U.S. Cl. CPC A01N 37/12; A01P 13/00; A01N 47/36

(57) ABSTRACT

A herbicide combination comprising an effective amount of components (A) and (B), where (A) denotes one or more fatty acid derivatives of the formula (I),

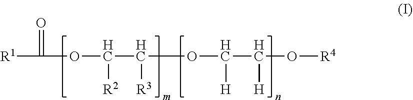

wherein
R¹ is an alkyl group containing 5 to 17 carbon atoms, which is linear or branched
R², R³ are, independently, hydrogen, methyl, ethyl or hydroxymethyl with the proviso that one of R² and R³ is hydrogen and the other is different from hydrogen
m, n are numbers from 0 to 17, with the proviso that m+n≥1 and m+n+p<18 where
   the different monomers can be arranged in statistical order, alternatingly or as a block copolymer,
R⁴ is hydrogen or an alkyl group containing 1 to 10 carbon atoms, which is linear or branched,
and
(B) denotes one or more sulfonyl urea herbicides,
   is particularly suitable for controlling unwanted vegetation.

The invention relates to herbicidal combinations comprising sulfonylurea herbicides and herbicidal fatty acid derivatives, methods for controlling unwanted vegetation by applying of such combinations and the use of such combinations for controlling unwanted vegetation.

It is known that fatty acids and derivatives thereof can be used for the preparation of herbicidal compositions.

U.S. Pat. No. 5,284,819 discloses a herbicidal activity of monoglycol esters of fatty acids such as pelargonic acid. Polyalkoxy esters of fatty acids such as pelargonic acid are proposed in European patent application 18158643.9.

WO 2015/004086 A1 discloses herbicidal combinations of pelargonic acid and certain ALS inhibitors. U.S. Pat. No. 6,383,585 B1 discloses herbicidal compositions containing a herbicidal fatty acid, such as pelargonic acid, and maleic hydrazide derivatives.

A compound from the substance class of the sulfonylurea herbicides inhibits the enzyme acetolactate synthase (ALS) which is responsible for the biosynthesis of branched amino acids such as L-valine, L-leucine and L-isoleucine. Therefore, this substance class—in addition to other substance classes—is, according to its mechanism of action, assigned to the group of the ALS (acetolactate synthase) inhibitors (see also http://www.hracglobal.eom/Portals/5/moaposter.pdf). Sulfonylureas are described, for example, in “The Pesticide Manual” 18^{th}, Edition, British Crop Protection Council 2018). These herbicides are in particular frequently applied on fields cultivated with soybeans and cereals. Uptake of these herbicides is via the roots and leaves.

The herbicidal activity of such herbicides is already on a high level, but generally depends on the application rate, the respective preparation form, the respective harmful plants to be controlled or the spectrum of harmful plants, the climatic and soil conditions, etc. Further criteria in this context are duration of action, or the breakdown rate, of the herbicide, the general crop plant compatibility and speed of action (more rapid onset of action), the activity spectrum and behavior toward follower crops (replanting problems) or the general flexibility of application (control of weeds in their various growth stages). If appropriate, changes in the susceptibility of harmful plants, which may occur on prolonged use of the herbicides or in limited geographical regions (control of tolerant or resistant weed species), may also have to be taken into account. The compensation of losses in action in the case of individual plants by increasing the application rates of the herbicides is only possible to a certain degree, for example because such a procedure reduces the selectivity of the herbicides or because the action is not improved, even when applying higher rates.

Thus, there is frequently a need for targeted synergistic activity against specific weed species, weed control with better Overall selectivity, generally lower amounts of active compounds used for equally good control results and for a reduced active compound input into the environment to avoid, for example, leaching and carry-over effects. There is also a need for developing one-shot applications to avoid labor-intensive multiple applications, and also to develop Systems for controlling the rate of action, where, in addition to an initial rapid control of weeds, there is also a slow, residual control.

A possible solution to the problems mentioned above may be to provide herbicide combinations, that is mixtures of a plurality of herbicides and/or other components from the group of the agrochemically active compounds of a different type and of formulation auxiliaries and additives customary in crop protection which contribute the desired additional properties. However, in the combined use of a plurality of active compounds, there are frequently phenomena of chemical, physical or biological incompatibility, for example lack of stability in a joint formulation, decomposition of an active compound or antagonism in the biological activity of the active compounds. For these reasons, potentially suitable combinations have to be selected in a targeted manner and tested experimentally for their suitability, it not being possible to safely discount a priori negative or positive results.

It was the object of the present invention to provide crop protection compositions as alternatives to the prior art, or as an improvement thereof.

Surprisingly it has now been found that this object can be achieved by the combination of certain fatty acid derivatives and at least one sulfonylurea which interact in a particularly favorable manner; for example when they are employed for controlling unwanted vegetation. Surprisingly, the activity of the combinations according to the invention of two active compounds, when used against weeds, is higher than the activities of the individual components. A true synergistic effect which could not have been predicted therefore exists, not just a complementation of action (additive effect).

Accordingly, the invention provides a herbicide combination comprising an effective amount of components (A) and (B), where (A) denotes one or more fatty acid derivatives of the formula (I),

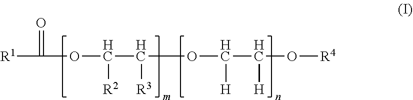

wherein
R¹ is an alkyl group containing 5 to 17 carbon atoms, which is linear or branched
R², R³ are, independently, hydrogen, methyl, ethyl or hydroxymethyl with the proviso that one of R² and R³ is hydrogen and the other is different from hydrogen
m, n are numbers from 0 to 17, with the proviso that m+n≥1, and m+n+p<18 where
   the different monomers can be arranged in statistical order, alternatingly or as a block copolymer;
R⁴ is hydrogen or an alkyl group containing 1 to 10 carbon atoms, which is linear or branched,
and
(B) denotes one or more sulfonyl urea herbicides.

In a further embodiment the invention provides a method for controlling unwanted vegetation wherein the herbicide combination of the invention is applied to the unwanted vegetation and/or its habitat.

In a further embodiment the invention the use of the herbicide combinations of the invention for controlling unwanted vegetation.

The herbicide combinations of the invention are particularly suitable for the control of unwanted vegetation showing herbicidal effects shortly after application as observed with certain contact herbicides without regrowth signs at the standard evaluation times of 21 and 28 days after application.

In addition, the combinations of the invention exhibit a synergistic effect, allowing thus the use of reduced amounts of both sulfonyl urea herbicides and the fatty acid derivatives to achieve the desired weed control in comparison to the separate application of the individual compounds.

Preferred as component (A) are one or more fatty acid derivatives of the formula (I),

wherein
R¹ is an alkyl group containing 5 to 13 carbon atoms, which is linear or branched;
R², R³ are, independently, hydrogen, methyl, ethyl or hydroxymethyl;
m, n are numbers from 0 to 12, with the proviso that m+n>4, and m+n<12 where
   the different monomers can be arranged in statistical order, alternatingly or as a block copolymer,
R⁴ is a methyl group.

In further preferred embodiments of the fatty acid derivatives of component (A), the symbols and indices in formula (I) have the following meanings:
R¹ is preferably a linear alkyl group.
R¹ is preferably an alkyl group with 5 to 11, preferably 7 to 9, carbon atoms, which is preferably linear.
R², R³ are preferably hydrogen, methyl or ethyl, more preferably hydrogen or methyl.
m is preferably a number from 0 to 5.

In a further preferred embodiment m is 0.

In a further embodiment is a number from 1 to 5.
n is preferably a number from 0 to <12.

If m is 0, n is a number from >4, preferably ≥5, more preferably >5 to <12, preferably <9, more preferably ≤7.

m+n is preferably >4, more preferably ≥5 and <12, preferably <9, more preferably ≤7.

The term “number” as used herein means 0 or a positive rational number. m and n are statistical values, therefore the monomer units m and n can be statistical mixtures.

Further preferred are fatty acid derivatives of formulae (I)), where
R¹ is a linear alkyl group with 7 to 9 carbon atoms;
m is 0;
n is a number from >4, preferably ≥5 to ≤9, preferably ≤7, and
R⁴ is a methyl group.

Particularly preferred are the fatty acid derivates of formula (I) pelargonic acid 6 EO ester methyl ether (A1) and C₈/C₁₀ fatty acid 6 EO ester methyl ether (A2) specified as A1 and A2 in the examples.

The fatty acid derivatives of the formula (I) can be prepared by methods know to those skilled in the art, as described e.g. in U.S. Pat. No. 7,595,291 B2 (BASF SE, Esterified alkyl alkoxylates used as low-foam surfactants). The compounds are usually prepared by condensation of fatty acid or fatty acid ester and the respective alcohol alkoxylate by removal of water or the alcohol, respectively, in the presence of an acidic catalyst. Alcohol alkoxylate derivatives are prepared by reacting a suitable precursor, e.g. an alcohol or and alkoxylated alcohol, with an alkylene oxide in the presence of an alkoxylation catalyst. Among others, NaOMe, KOMe, NaOH, KOH, alkaline earth-based catalysts or double metal cyanide (DMC) catalysts can be used (e.g. SHELL OIL COMPANY—US2012/310004, 2012, A1 Nonyl alcohols with a low degree of branching and their derivatives). The composition of the alkyene oxide chain can be either a single pure alkylene oxide, preferably selected from the group of ethylene oxide, propylene oxide or butylene oxide, or a copolymer of a binary or ternary mixture of alkylene oxides. The copolymers may be arranged in a statistical distribution, alternatingly, as block copolymers or a mixture thereof.

Compounds of comparable chemical compositions can be realized by reacting a carboxylic acid ester with one or more alkylene oxides in the presence of a suitable insertion catalyst. The ester is preferably, but not exclusively, a methyl ester. Specific procedures are disclosed, e.g., in Scholz H. J., Stühler H., Quack J., Schuler W., Trautmann, M. (1988) Verfahrung zur Herstellung von Carbonsäureestern von Alkylenglykolethern und deren Verwendung, D E 3810793A1 (Hoechst), Weerasooriya U, Robertson D T, Lin J, Leach B E, Aeschbacher C L, Sandoval T S (1995) Process for alkoxylation of esters and products produced therefrom, U.S. Pat. No. 5,386,045, and Tanaka T, Imamaka T, Kaeaguchi T, Nagumo H (1997) Process for producing ester alkoxide compound and surfactant comprising ester alkoxylate compound, EP0783012.

Use can be further made of the detailed instructions in the examples section which describe in detail how to prepare these and any further compounds of the invention.

As component (B) at least one sulfonylurea herbicide is employed. Suitable sulfonylurea herbicides are described, for example, in “The Pesticide Manual” 18^{th}, Edition, British Crop Protection Council 2018).

Suitable sulfonylurea herbicides include pyrimidinylsulfonylurea herbicides such as:

amidosulfuron (B1), azimsulfuron (B2), bensulfuron (B3), chlorimuron (B4), cyclosulfamuron (B5), ethoxysulfuron (B6), flazasulfuron (B7), flucetosulfuron B8), flupyrsulfuron (B9), foramsulfuron (B10), halosulfuron (B11), imazosulfuron (B12), mesosulfuron (B13), metazosulfuron (B14), methiopyrisulfuron (B15), monosulfuron (B16), nicosulfuron (B17), orthosulfamuron (B18), oxasulfuron (B19), primisulfuron (B20), propyrisulfuron (B21), pyrazosulfuron (B22), rimsulfuron (B23), sulfometuron (B24), sulfosulfuron (B25), trifloxysulfuron (B26), zuomihuanglong (B27),

as well as triazinylsulfonylurea herbicides such as

chlorsulfuron (B28), cinosulfuron (B29), ethametsulfuron (B30), iodosulfuron (B31), iofensulfuron (B32), metsulfuron (B33), prosulfuron (B34), thifensulfuron (B35), triasulfuron (B36), tribenuron (B37), triflusulfuron (B38) and tritosulfuron (B39).

In one embodiment the sulfonyl urea herbicide is selected from at least one of iodosulfuron-methyl, foramsulfuron, mesosulfuron-methyl, flazasulfuron, amidosulfuron, ethoxysulfuron thiencarbazone-methy and nicosulfuron.

Particularly preferred are iodosulfuron (B31), preferably iodosulfuron methyl, in particular the sodium salt of iodosulfuron methyl and nicosulfuron (B17).

Preferred combinations of components (A) and (B) are combinations of the compounds:

A1+B1, A1+B2, A1+B3, A1+B4, A1+B5, A1+B6, A1+B7, A1+B8, A1+B9, A1+B10, A1+B11, A1+B12, A1+B13, A1+B14, A1+B15, A1+B16, A1+B17, A1+B18, A1+B19, A1+B20, A1+B21, A1+B22, A1+B23, A1+B24, A1+B25, A1+B26, A1+B27, A1+B28, A1+B29, A1+B30, A1+B31, A1+B32, A1+B33, A1+B34, A1+B35, A1+B36, A1+B37, A1+B38 and A1+B39; A2+B1, A2+B2, A2+B3, A2+B4, A2+B5, A2+B6, A2+B7, A2+B8, A2+B9, A2+B10, A2+B11, A2+B12, A2+B13, A2+B14, A2+B15, A2+B16, A2+B17, A2+B18, A2+B19, A2+B20, A2+B21, A2+B22, A2+B23, A2+B24, A2+B25, A2+B26, A2+B27, A2+B28, A2+B29, A2+B30, A2+B31, A2+B32, A2+B33, A2+B34, A2+B35, A2+B36, A2+B37, A2+B38 and A2+B39;

More preferred are the combinations A1+B1, A1+B2, A2+B1 and A2+B2. Particularly preferred are the combinations A1+B1 and A1+B2.

In each of the preferred, more preferred and particularly preferred combinations the weight ratio of (A) to (B) compounds to the preferred or more preferred ratios stated below.

In a further embodiment components (B) denotes two or more, preferably two, sulfonylurea herbicide, preferably selected from compounds B1 to B39.

Additionally, the herbicide combination of the invention may comprise further components, for example agrochemically active compounds of a different type and/or the formulation auxiliaries and/or additives customary in crop protection, or may be used together with these.

In a preferred embodiment, the herbicide combination according to the invention comprises an effective amount of at least one fatty acid derivative (A) and at least one of the above-mentioned sulfonylurea herbicides and/or has synergistic activities. The synergistic actions can be observed, for example, in the case of joint application, for example as a ready-to-use formulation, co-formulation or as a tank mix. It is also possible to apply the herbicides or the herbicide combination in a plurality of portions (sequential application), for example post-emergence applications or early post-emergence applications followed by medium or late post-emergence applications. Here, the joint application of the herbicide combination according to the invention is preferred.

The synergistic effects permit a reduction of the application rates of the individual herbicides, a higher and/or longer efficacy at the same application rate, the control of species which were as yet uncontrolled (gaps), control of species which are tolerant or resistant to individual herbicides or to a number of* *herbicides, an extension of the period of application and/or a reduction in the number of individual applications required and—as a result for the user—weed control Systems which are more advantageous economically and ecologically.

In the herbicide combination according to the invention, the application rate of component (A) may vary within a wide range; for example, the application rate should be at least 5000 g of AS/ha (hereinbelow, AS/ha means “active substance per hectare”=based on 100% active compound), but preferably between 5000 and 50000 g of AS/ha, more preferably between 10000 and 40000 g of AS/ha and most preferably between 15000-30000 g of AS/ha.

In the herbicide combination according to the invention, the application rate of the sulfonylurea herbicide (B) may vary within a wide range, for example between 1 g and 200 g of AS/ha, with a relatively wide spectrum of harmful plants being controlled.

If iodosulfuron is used, the application rate is preferably in a range of 1 and 10 g of AS/ha and even more preferably between 5-10 g of AS/ha.

If nicosulfuron is used, the application rate is preferably in a range of 10-40 g of AS/ha and even more preferably between 20-40 g of AS/ha.

If mesosulfuron is used, the application rate is preferably in a range of 5 and 30 g of AS/ha and even more preferably between 5 and 15 g of AS/ha.

If foramsulfuron is used, the application rate is preferably in a range of 15-60 g of AS/ha and even more preferably between 30-60 and particularly preferably between 30-45 g of AS/ha.

If thiencarbazone is used, the application rate is preferably in a range of 10 and 30 g of AS/ha.

If flazasulfuron is used, the application rate is preferably in a range of 10 and 50 g of AS/ha.

If amidosulfuron is used, the application rate is preferably in a range of 30 and 60 g of AS/ha.

If ethoxysulfuron is used, the application rate is preferably in a range of 60 and 150 g of AS/ha.

Ranges of suitable ratios of fatty acid derivatives (A) and the sulfonylurea herbicide (B) can be found, for example, by looking at the application rates mentioned for the individual compounds. In the combination according to the invention, the application rates can generally be reduced. Preferred mixing ratios of fatty acid derivatives (hereinbelow referred to as component “A” or just as “A”) and above-mentioned herbicidally active ALS inhibitor (hereinbelow referred to as component “B” or just as “B”) described according to the invention in the combination according to the invention are characterized by the following weight ratios:

The weight ratio (A):(B) of the components (A) and (B) is generally in the range of from 30000:1 to 12.5:1, preferably 10000:1 to 50:1, more preferably 10000:1 to 250:1, in particular 10000:1 to 500:1.

The following weight ratios apply to the preferred combinations of fatty acid derivatives plus sulfonylurea herbicide.

When using fatty acid derivatives and iodosulfuron, the weight ratio is preferably in a range from 10000:1 to 500:1 and even more preferably in the range from 10000:1 to 1000:1.

When using fatty acid derivatives and nicosulfuron, the weight ratio is preferably in the range from 5000:1 to 250:1 and even more preferably in the range from 5000:1 to 500:1.

When using fatty acid derivatives and foramsulfuron, the weight ratio is preferably in the range from 4000:1 to 83:1 and even more preferably in the range from 2000:1 to 160:1 and particularly preferably in the range from 1000:1 to 250:1.

When using fatty acid derivatives and mesosulfuron, the weight ratio is preferably in a range from 10000:1 to 167:1 and even more preferably in the range from 5000:1 to 333:1 and particularly preferably in the range from 5000:1 to 500:1.

When using fatty acid derivatives and thiencarbazone, the weight ratio is preferably in a range from 5000:1 to 167:1 and even more preferably in the range from 4000:1 to 333:1 and particularly preferably in the range from 2500:1 to 500:1.

When using fatty acid derivatives and flazasulfuron, the weight ratio is preferably in a range from 5000:1 to 100:1 and even more preferably in the range from 4000:1 to 200:1.

When using fatty acid derivatives and amidosulfuron, the weight ratio is preferably in a range from 2000:1 to 83:1 and even more preferably in the range from 1500:1 to 150:1.

When using fatty acid derivatives and ethoxysulfuron, the weight ratio is preferably in a range from 2000:1 to 30:1 and even more preferably in the range from 1500:1 to 150:1.

The herbicide combination according to the invention may furthermore comprise, as additional further components, various agrochemically active compounds, for example from the group of the safeners, fungicides, insecticides, acaricides, nematicides, bird repellants, soil structure improvers, plant nutrients (fertilizers), and herbicides and plant growth regulators which differ structurally from the herbicidally active compounds employed in accordance with the invention, or from the group of the formulation auxiliaries and additives customary in crop protection.

The active compound combinations according to the invention have very good herbicidal properties and can be used for controlling unwanted vegetation, in particular weeds. Here, weeds are understood to mean all plants which grow at sites where they are unwanted.

The herbicide combinations according to the invention have excellent herbicidal efficacy against a broad spectrum of economically important monocotyledonous and dicotyledonous annual harmful plants. The herbicide combinations act efficiently even on perennial harmful plants which produce shoots from rhizomes, root stocks and other perennial organs which are difficult to control.

Specific examples may be mentioned of some representatives of the monocotyledonous and dicotyledonous weed flora which can be controlled by the compositions according to the invention, without the enumeration being restricted to certain species.

Monocotyledonous harmful plants of the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Eleteranthera, Imperata, Ischaemum, Leptochloa, Folium, Monochoria, Panicum, Paspalum, Phalaris, Phleum, Poa, Rottboellia, Sagittaria, Scirpus, Setaria, Sorghum.

Dicotyledonous weeds of the genera: Abutilon, Amaranthus, Ambrosia, Anoda, Anthemis, Aphanes, Artemisia, Atriplex, Beilis, Bidens, Capsella, Carduus, Cassia, Centaurea, Chenopodium, Cirsium, Convolvulus, Conyza, Datura, Desmodium, Emex, Erigeron, Erysimum, Euphorbia, Galeopsis, Galinsoga, Galium, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Ulex, Urtica, Veronica, Viola, Xanthium.

The herbicide combinations of the invention are also effective against weeds from the division Teridophyta, like horsetail (equisetum) or bracken.

The herbicide combinations of the invention are also efficient against moss. Specific examples may be mentioned of some representatives of the mosses which can be controlled by the compositions according to the invention, without the enumeration being restricted to certain species: Polytrichum commune, Tortula muralis, Hypnum cypressiforme, Grimmia pulvinata, Calliergonella cuspidate, Pseudoscleropodium purum, Brachythecium rutabulum, Rhytidiadelphus triquetrus and Rhytidiadelphus squarrosus.

The herbicide combinations of the invention can also be used as effective for the removal of green algae, lichen, mould and fungal stains from all kinds of hard surfaces, including concrete, brick paving, patios, paths, fences, sheds, greenhouse and conservatory glass.

If the active compounds are applied post-emergence to the green parts of the plants, growth likewise stops drastically a very short time after the treatment, and the weed plants show damage symptoms of different degree of severity that include complete damage after a certain time, so that in this manner weed infestation is eliminated very early and in a sustained manner.

In one embodiment, the herbicide combinations according to the invention can be used as total herbicides for controlling weeds, for example on non-crop areas such as paths, squares and also under trees and shrubs, rail tracks etc. The active compound combinations according to the invention are distinguished by an action which has a particularly quick onset and lasts for a long time.

In a preferred embodiment of the invention the herbicide combinations are used to control unwanted vegetation in crops, e.g. to control residual plants from the previous harvest.

The herbicide combination according to the invention can be prepared by known processes, for example as mixed formulations of the individual components, if appropriate with further active compounds, additives and/or customary formulation auxiliaries, which combinations are then applied in a customary manner diluted with water, or as tank mixes by joint dilution of the components, formulated separately or formulated partially separately, with water. Also possible is the split application of the separately formulated or partially separately formulated individual components. It is also possible to use the herbicides or the herbicide combination in a plurality of portions (sequential application), for example by the post-emergence method or early post-emergence applications followed by medium or late post-emergence applications. Preference is given to the joint use of the active compounds in the respective combination

The fatty acid derivatives (A) and the at least one sulfonylurea herbicide employed in accordance with the invention can be converted jointly or separately into customary formulations. Possible formulations include, for example: soluble liquids (SL), emulsions (EW) such as oil-in-water and water-in-oil emulsions, microemulsions (ME), sprayable solutions, suspension concentrates (SC), sulspoemulsions (SE), other oil-, (poly)glycol-, glycerol-based, optionally water containing dispersions, oil-miscible solutions (OF), wettable powders (WP), water-soluble powders (SP), water-soluble concentrates, emulsifiable concentrates (EC), capsule suspensions (CS), dusting products (DP), granules for scattering and soil application, granules (GR) in the form of microgranules, granules for scattering and soil application, granules (GR) in the form of microgranules, spray granules, coated granules and adsorption granules, water-dispersible granules (WG), water-soluble granules (SG), ULV formulations, microcapsules and waxes. The compounds according to the invention can also be offered as AL type, which includes undiluted pure product or so called ready-to-use preparations. These individual types of formulations are known in principle and are described, for example, in: Winnacker-Küchler, “Chemische Technologie” [Chemical technology], Volume 7, C. Hanser Verlag Munich, 4^{th} Ed. 1986, Wade van Walkenburg, “Pesticide Formulations”, Marcel Dekker, N.Y., 1973; K. Martens, “Spray Drying” Handbook, 3^{rd} Ed. 1979, G. Goodwin Ltd. London. Apart from any conventional application system an application by drones is feasible.

The necessary formulation aids, such as inert materials, surfactants, solvents and further additives, are likewise known and are described, for example, in: Watkins, “Handbook of Insecticide Dust Diluents and Carriers”, 2^{nd} Ed., Darland Books, Caldwell N.J., H. v. Olphen, “Introduction to Clay Colloid Chemistry”; 2^{nd} Ed., J. Wiley & Sons, N.Y.; C. Marsden, “Solvents Guide”; 2^{nd} Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964, Scho\ddot{n}feldt, “Grenzflächenaktive Äthylenoxidaddukte” [Interface-active ethylene oxide adducts], Wiss. Verlagsgesell., Stuttgart 1976; Winnacker-Küchler, “Chemische Technologie”, Volume 7, C. Hanser Verlag Munich, 4^{th} Ed. 1986.

The herbicide combination according to the invention may further comprise one or more suitable emulsifier components enabling an emulsion, e.g. an oil in water emulsion, to be formed when the composition of the invention is added to water.

Preferably, the emulsifier component is at least one non-ionic surfactant selected from the group of alkoxylated alcohols, ethoxylated alcohols, ethopropoxylated alcohols, alkylphenolethoxylates, alkoxylated tristyrylphenols, alkoxylated tributyl-phenols, alkylaminethoxylates, ethoxylated vegetable oils including their hydrogenates, polyadducts of ethylene oxide and propylene oxide (e.g. polyoxyethylene-polyoxypropylene block copolymers and their derivatives), ethoxylated fatty acids, nonionic polymeric surfactants (e.g. polyvinylalcohol, polyvinylpyrrolidone, polymethacrylates and their derivatives), sorbitan esters and their ethoxylates, sorbitolesters, propylene glycol esters of fatty acids, alkylpolyglycosides, glucamides and polyglycerolesters.

The composition according to the invention may also comprise—as an additional emulsifier component—an anionic surfactant as a salt of a multivalent cation, e.g. calcium. Examples of such anionic surfactants are calcium salts of alkylarylsulfonates CALSOGEN® 4814 (Clariant), NANSA EVM 70/2E (Huntsmann) and Emulsifier 1371 A (Lanxess).

The composition of the invention may further comprise one or more organic solvents. In combination with the other components, the solvent should give preferably a homogeneous and even more preferably a clear composition with good emulsifying properties upon dilution into water.

A suitable organic solvent can be chosen from the group of organic water-unsoluble or water soluble solvents. Organic water-unsoluble solvents are preferably selected from the group consisting of aromatic hydrocarbons, aliphatic hydrocarbons, fatty acid dimethylamides, carboxylic acid esters, alcohols, polyalkylene glycols, esters of plant oils, glycerol ester oils and mixtures thereof. Water soluble solvents are, e.g., alcohols.

Other suitable organic solvents which may be employed in the compositions according to the invention may be water-soluble. They are preferably selected from the group consisting of water-soluble alcohols such as glycerins and propylenglycol, polyalkylene glycols, alkylene carbonates and carboxylic acid esters (eg. citric acid esters, dibasic esters and lactate esters), alkylpyrrolidons (N-Methylpyrrolidone, N-butylpyrrolidone), methyl-5-(dimethylamino)-2-methyl-5-oxopentanoate (Rhodiasolv Polarclean), DMSO and lactones.

The content of the optional organic solvent in the herbicide combination according to the invention is preferably 0% to 90% by weight, more preferably 5% to 60% by weight and most preferably between 10% to 50% by weight.

In a preferred embodiment the herbicide combination according to the invention does not contain an organic solvent.

The formulations are produced in a known manner, for example by mixing the active compounds with extenders, i.e. liquid solvents, pressurized liquefied gases and/or solid carriers, optionally with use of surfactants, i.e. emulsifiers and/or dispersants and/or foam formers.

In general, the formulations comprise between 1 and 100% by weight of herbicide combination, preferably between 2.5 and 95% by weight and most preferably between 5% to 90% by weight.

Based on these formulations, it is also possible to produce combinations with other pesticidally active compounds, such as, for example further herbicides, insecticides, acaricides, fungicides, and also with safeners, fertilizers and/or growth regulators, for example in the form of a finished formulation or as a tank mix.

Components which can be used in combination with the compositions according to the invention in mixed formulations or in the tank mix are, for example, known active compounds as they are described, for example, in Weed Research 26, 441-445 (1986), or “The Pesticide Manual”, 17^{th} edition, The British Crop Protection Council and the Royal Soc. of Chemistry, 2015 and adjuvants as described in “Compendium of adjuvants for herbicides” (www.herbicide-adjuvants.com).

The herbicide combination according to the invention can be used as such, in the form of its formulations or in the use forms prepared therefrom by further dilution, such as ready-to-use solutions, suspensions, emulsions, powders, pastes and granules. Application is accomplished in a customary manner, for example by watering, spraying, atomizing or broadcasting.

The herbicide combinations according to the invention are generally applied in the form of finished formulations. However, the active compounds contained in the active compound combinations can, as individual formulations, also be mixed during use, i.e. be applied in the form of tank mixes.

The herbicide combinations of the invention are particularly useful for burn-down applications.

By virtue of their herbicidal and plant-growth-regulatory properties, the herbicide combinations of the invention can also be employed for controlling harmful plants in crops of genetically modified plants or plants modified by conventional mutagenesis. In general, the transgenic plants are distinguished by especially advantageous properties, for example by resistances to certain pesticides, mainly certain herbicides, resistances to plant diseases or causative organisms of plant diseases, such as certain insects or microorganisms such as fungi, bacteria or viruses. Other specific characteristics relate, for example, to the harvested material with regard to quantity, quality, storability, composition and specific constituents. Thus, transgenic plants are known whose starch content is increased, or whose starch quality is altered, or those where the harvested material has a different fatty acid composition.

For proper use in transgenic crops today one of ordinary skill in the art could determine an appropriate application dosage, which may vary with crop, objective weeds, and weather conditions and so on.

The compositions of the present invention may be utilized without modification or may be diluted with water to give a solution or an emulsion and applied to weeds.

As products, the inventive compositions are in a concentrated form whereas the end-user generally employs diluted compositions but application as concentrate is also possible. Said compositions may be diluted to concentrations down to 1.0 to 20% of the herbicidal ester and more preferably 1-10% and most preferably 3 to 10% of herbicidal ester. The doses usually are in the range of about 5 to 200 kg a.i./ha, preferably 5 to 100 kg a.i./ha, and most preferably 5 to 50 kg a.i./ha.

One of ordinary skill in the art could determine an appropriate application dosage, which may vary with crop, objective weeds, and weather conditions and so on.

The invention therefore also provides a method of controlling unwanted vegetation, preferably in crops of plants, where herbicide combination according to the invention is/are applied to the unwanted vegetation (for example harmful plants such as monocotyledonous or dicotyledonous weeds or undesired crop plants), to the seeds (for example grains, seeds or vegetative propagules such as tubers or shoot parts with buds) or to the area on which the unwanted vegetation grows (for example the area under cultivation). In this context, the herbicide combinations according to the invention can be applied for example post-emergence, pre-emergence or pre-sowing (if appropriate also by incorporation into the soil).

The invention therefore also provides methods for sucker control, desiccation and defoliation, chemical pruning, e.g. flower (blossom) thinning applications in orchards and pinching in ornamentals and vegetables by applying herbicide combinations of the invention.

The good herbicidal action of the herbicide combinations of the invention can be seen from the examples which follow. While the individual active compounds show weaknesses in their herbicidal action, all combinations show a very good action on weeds which exceeds a simple sum of actions.

A synergistic effect in herbicides is always present when the herbicidal action of the active compound combination exceeds the action of the active compounds when applied individually.

For a clearer understanding of the invention, specific examples are set forth below. These examples are merely illustrations and are not to be understood as limiting the scope and underlying principles of the invention in any way. Indeed, various modifications of the invention in addition to those shown and described herein will become apparent to those skilled in the art from the following examples and fore-going description. Such modifications are also intended to fall within the scope of the appended claims.

### EXAMPLES

The percentages stated hereinafter are percent by weight (% by weight), unless explicitly stated otherwise.

### Example 1: Preparation of the Fatty Acid Derivatives of the Invention

The compounds according to the invention are listed in Table A. All test substances were liquid, which makes them easy to handle and pourable.

TABLE A

| | | | | | | | | Conversion |
|---|---|---|---|---|---|---|---|---|
| | | | | | | | | rate |
| | | | | | | | | (according |
| Test | | | | | | | | to acid |
| substance | Description | R1 | R2 | R3 | m | n | R4 | value) |
| A1 | Pelargonic acid | C8 | H | H | 0 | C | Me | >85 |
| | 6 EO ester methyl | | | | | | | |
| | ether | | | | | | | |
| A2 | C8/C10 fatty acid | C7/C9 | H | H | 0 | C | Me | >85 |
| | 6 EO ester methyl | | | | | | | |
| | ether | | | | | | | |

General Procedure for the Synthesis of Alcohol Ethoxylate Esters A1 and A2

Alcohol ethoxylates were synthesized according to standard alkoxylation procedures as described in (e.g. US2012/310004). In a flask, equipped with a Dean-Stark-head, alcohol ethoxylates or glycerol were mixed with the respective carboxylic acid at a stoichiometric mixture, a catalytic amount of sulfuric acid was added and the mixture was heated up to 200° C. upon stirring under a constant stream of nitrogen. Reaction progress was followed by water separation and acid value. The final product was characterized by NMR spectroscopy and titration methods.

### Example 2: Results of Greenhouse Trials to Test Herbicidal Activity of Inventive Compounds in Combination with Sulfonylurea Herbicides

Standard post emergence herbicide application procedures were used, as described below, to apply inventive compounds in combination with sulfonylurea herbicides.

Seed of monocotyledonous and dicotyledonous harmful plants such as Brassica napus (BRSNW) Abutilon theophrasti (ABUTH), Alopecurus myosuroides (ALOMY), Amaranthus retroflexus (AMARE), Digitaria Sanguinalis (DIGSA), Echinochloa crus-galli (ECHCG), Erigeron canadensis (ERICA), Galium aparine (GALAP), Lolium perenne (LOLPE), Sectaria viridis (SETVI), Solanun nigrum (SOLNI), Viola arvensis (VIOAR) were sowed in 18 cm² pots. The plants were placed in a greenhouse under controlled environmental conditions, and sub-irrigation. About one week after emergence, seedlings were thinned as needed, including removal of any unhealthy or abnormal plants, to create a uniform series of test pots.

The plants were maintained for the duration of the test in the greenhouse, where they received a mean of 70 μmol m-2 s-1 of light per day/night. Temperatures averages about 24° C. during the day and about 20° C. during the night. Plants were sub-irrigated throughout the test to ensure adequate soil moisture levels.

Pots were assigned to different treatment in a randomized experimental design. A set of pots was left untreated as a reference against which effects of the treatments could later be evaluated. Application of tested formulations was made in a spray cabin model 01S-15E designed by CheckTec using the following parameters:
Two edge nozzle Lechler OC2, 200 L/ha, 3 bars.
Two edge nozzle Lechler OC3, 500 L/ha, 3 bars.

The distance of the nozzle from the plants was between 50 to 53 cm. and the nozzle spacing was 50 cm.

After treatment, pots were returned to the greenhouse until ready for evaluation. Evaluations were performed at different times after application (DAT: days after treatment), depending on the experiment.

For evaluation of herbicidal effectiveness, all plants in the test were examined by a single technician, who recorded percent control, a visual measurement of the effectiveness of each treatment by comparison with untreated plants. Control of 0% indicates no effect, and control of 100% indicates that all of the plants are completely dead. The reported % control values represent the average for all replicates of each treatment.

Iodosulfuron-methyl-sodium and Nicosulfuron were applied as dilutions of the active ingredient in water.

Generally, the compounds according to the invention displayed particularly similar or better herbicidal activity than the standard products in post-emergence application method against several harmful plants selected from the previous group.

TABLE 1
Effectiveness control in Solanum nigrum - SOLNI Spray Vol: 500 L/ha

| Pest Code: SOLNI | | | | Treatment-Evaluation Interval | | | | |
|---|---|---|---|---|---|---|---|---|
| N° | Treatment | Rate | Unit | 1 DAT | 2 DAT | 7 DAT | 15 DAT | 21 DAT |
| 1 | A1 | 0.1 | % w/w | 0.00 | 0.00 | 0.00 | 0.00 | 0.00 |
| 2 | A1 | 2.5 | % w/w | 10.00 | 21.25 | 13.75 | 7.75 | 5.00 |
| 3 | A1 | 5 | % w/w | 26.00 | 42.50 | 32.50 | 28.75 | 27.50 |
| 4 | A1 | 10 | % w/w | 65.50 | 75.50 | 72.50 | 63.75 | 53.00 |
| 5 | A1 | 0.1 | % w/w | 0.00 | 0.00 | 10.00 | 25.00 | 50.00 |
| | Iodosulfuron- | 10 | g Al/ha | | | | | |
| | methyl-sodium | | | | | | | |
| 6 | A1 | 2.5 | % w/w | 3.00 | 5.00 | 6.25 | 13.25 | 25.00 |
| | Iodosulfuron- | 10 | g Al/ha | | | | | |
| | methyl-sodium | | | | | | | |
| 7 | A1 | 5 | % w/w | 45.00 | 60.00 | 73.75 | 90.75 | 92.00 |
| | Iodosulfuron- | 10 | g Al/ha | | | | | |
| | methyl-sodium | | | | | | | |
| 8 | A1 | 10 | % w/w | 73.75 | 78.75 | 83.00 | 95.00 | 95.00 |
| | Iodosulfuron- | 10 | g Al/ha | | | | | |
| | methyl-sodium | | | | | | | |
| 9 | Iodosulfuron- | 10 | g Al/ha | 0.00 | 0.000 | 5.00 | 25.00 | 47.50 |
| | methyl-sodium | | | | | | | |

TABLE 2
Effectiveness control in Solanum nigrum - SOLNI Spray Vol: 200 L/ha

| Pest Code: SOLNI | | | | Treatment-Evaluation Interval | | | | |
|---|---|---|---|---|---|---|---|---|
| N° | Treatment | Rate | Unit | 1 DAT | 2 DAT | 7 DAT | 15 DAT | 21 DAT |
| 1 | A1 | 0.1 | % w/w | 0.00 | 0.00 | 0.00 | 0.00 | 0.00 |
| 2 | A1 | 2.5 | % w/w | 0.00 | 0.00 | 0.00 | 0.00 | 0.00 |
| 3 | A1 | 5 | % w/w | 0.75 | 3.50 | 3.50 | 0.00 | 0.00 |
| 4 | A1 | 10 | % w/w | 25.00 | 48.50 | 50.50 | 47.50 | 38.75 |
| 5 | A1 | 0.1 | % w/w | 0.00 | 0.00 | 0.00 | 8.75 | 9.25 |
| | Iodosulfuron- | 10 | g Al/ha | | | | | |
| | methyl-sodium | | | | | | | |
| 6 | A1 | 2.5 | % w/w | 0.00 | 0.00 | 0.00 | 10.00 | 10.00 |
| | Iodosulfuron- | 10 | g Al/ha | | | | | |
| | methyl-sodium | | | | | | | |
| 7 | A1 | 5 | % w/w | 2.25 | 6.75 | 6.75 | 17.00 | 22.50 |
| | Iodosulfuron- | 10 | g Al/ha | | | | | |
| | methyl-sodium | | | | | | | |
| 8 | A1 | 10 | % w/w | 30.75 | 48.50 | 56.00 | 66.50 | 66.50 |
| | Iodosulfuron- | 10 | g Al/ha | | | | | |
| | methyl-sodium | | | | | | | |
| 9 | Iodosulfuron- | 10 | g Al/ha | 0.00 | 0.00 | 0.00 | 12.50 | 13.75 |
| | methyl-sodium | | | | | | | |

TABLE 3
Effectiveness control in Sectaria Viridis - SETVI Spray Vol: 200 L/ha

| | | | | Treatment-Evaluation Interval | | | | | | |
|---|---|---|---|---|---|---|---|---|---|---|
| Pest code: SETVI | | | | 1 | 2 | 7 | 10 | 16 | 22 | 28 |
| N° | Treatment | Rate | Unit | DAT | DAT | DAT | DAT | DAT | DAT | DAT |
| 1 | Nicosulfuron | 40 | g Al/ha | 0.00 | 0.00 | 5.00 | 7.00 | 10.75 | 7.75 | 7.00 |
| 2 | A1 | 7.5 | % w/w | 18.50 | 23.00 | 30.00 | 38.00 | 63.25 | 63.25 | 64.00 |
| | Nicosulfuron | 20 | g Al/ha | | | | | | | |
| 3 | A1 | 7.5 | % w/w | 20.00 | 23.50 | 35.00 | 64.50 | 83.25 | 83.25 | 84.50 |
| | Nicosulfuron | 40 | g Al/ha | | | | | | | |
| 4 | A1 | 7.5 | % w/w | 19.25 | 21.25 | 21.25 | 20.00 | 16.00 | 16.00 | 0.00 |

TABLE 4
Effectiveness control in Galium aparine - GALAP Spray Vol: 200 L/ha

| | | | | Treatment-Evaluation Interval | | | | | | |
|---|---|---|---|---|---|---|---|---|---|---|
| Pest code: GALAP | | | | 1 | 2 | 7 | 10 | 16 | 22 | 28 |
| N° | Treatment | Rate | Unit | DAT | DAT | DAT | DAT | DAT | DAT | DAT |
| 1 | Nicosulfuron | 40 | g Al/ha | 0.00 | 0.00 | 3.00 | 10.00 | 12.75 | 12.75 | 12.75 |
| 2 | A1 | 7.5 | % w/w | 31.25 | 33.50 | 50.00 | 77.50 | 82.50 | 82.50 | 82.50 |
| | Nicosulfuron | 20 | g Al/ha | | | | | | | |
| 3 | A1 | 7.5 | % w/w | 32.75 | 33.50 | 60.00 | 85.00 | 88.50 | 88.50 | 88.50 |
| | Nicosulfuron | 40 | g Al/ha | | | | | | | |
| 4 | A1 | 7.5 | % w/w | 31.75 | 34.00 | 35.75 | 20.00 | 10.75 | 10.75 | 10.75 |

TABLE 5
Effectiveness control in Brassica napus - BRSNW Spray Vol: 200 L/ha

| | | | | Treatment-Evaluation Interval | | | | | | |
|---|---|---|---|---|---|---|---|---|---|---|
| Pest Code: BRSNW | | | | 1 | 2 | 7 | 10 | 16 | 22 | 28 |
| N° | Treatment | Rate | Unit | DAT | DAT | DAT | DAT | DAT | DAT | DAT |
| 1 | Iodosulfuron- | 10 | g Al/ha | 0.00 | 0.00 | 6.75 | 8.50 | 50.75 | 99.00 | 99.00 |
| | methyl-sodium | | | | | | | | | |
| 2 | A1 | 7.5 | % w/w | 77.50 | 81.00 | 85.00 | 86.75 | 93.75 | 96.75 | 96.75 |
| | Iodosulfuron- | 5 | g Al/ha | | | | | | | |
| | methyl-sodium | | | | | | | | | |
| 3 | A1 | 7.5 | % w/w | 75.75 | 78.50 | 85.00 | 87.50 | 90.25 | 94.50 | 94.50 |
| | Iodosulfuron- | 7.5 | g Al/ha | | | | | | | |
| | methyl-sodium | | | | | | | | | |
| 4 | A1 | 7.5 | % w/w | 76.50 | 79.00 | 85.75 | 88.00 | 93.00 | 95.50 | 95.50 |
| | Iodosulfuron- | 10 | g Al/ha | | | | | | | |
| | methyl-sodium | | | | | | | | | |
| 5 | A1 | 7.5 | % w/w | 74.25 | 78.00 | 75.00 | 56.25 | 39.25 | 33.50 | 32.50 |

TABLE 6
Effectiveness control in Lolium perenne - LOLPE Spray Vol: 200 L/ha

| | | | | Treatment-Evaluation Interval | | | | | | |
|---|---|---|---|---|---|---|---|---|---|---|
| Pest Code: LOLPE | | | | 1 | 2 | 7 | 10 | 16 | 22 | 28 |
| N° | Treatment | Rate | Unit | DAT | DAT | DAT | DAT | DAT | DAT | DAT |
| 1 | Iodosulfuron- | 10 | g Al/ha | 0.00 | 0.00 | 0.00 | 0.00 | 0.00 | 0.00 | 0.00 |
| | methyl-sodium | | | | | | | | | |
| 2 | A1 | 7.5 | % w/w | 11.50 | 11.50 | 11.50 | 35.50 | 40.00 | 68.75 | 68.75 |
| | Iodosulfuron- | 5 | g Al/ha | | | | | | | |
| | methyl-sodium | | | | | | | | | |
| 3 | A1 | 7.5 | % w/w | 12.00 | 12.00 | 12.00 | 46.00 | 48.00 | 70.00 | 73.75 |
| | Iodosulfuron- | 7.5 | g Al/ha | | | | | | | |
| | methyl-sodium | | | | | | | | | |
| 4 | A1 | 7.5 | % w/w | 10.00 | 10.00 | 10.00 | 40.75 | 47.50 | 72.50 | 82.75 |
| | Iodosulfuron- | 10 | g Al/ha | | | | | | | |
| | methyl-sodium | | | | | | | | | |
| 5 | A1 | 7.5 | % w/w | 11.50 | 11.50 | 5.00 | 0.00 | 0.00 | 0.00 | 0.00 |

1. A herbicide combination comprising an effective amount of components (A) and (B), where (A) is one or more fatty acid derivatives of the formula (I), 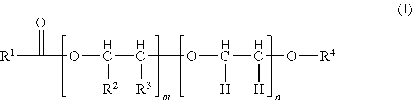
wherein
R¹ is an alkyl group containing 5 to 17 carbon atoms, which is linear or branched
R², R³ are, independently, hydrogen, methyl, ethyl or hydroxymethyl with the proviso that one of R² and R³ is hydrogen and the other is different from hydrogen
m, n are numbers from 0 to 17, with the proviso that m+n≥1 and m+n+p<18 where
the different monomers can be arranged in statistical order, alternatingly or as a block copolymer,
R⁴ is hydrogen or an alkyl group containing 1 to 10 carbon atoms, which is linear or branched,
and
(B) is one or more sulfonyl urea herbicides.

2. The herbicide combination as claimed in claim 1, wherein
R¹ is an alkyl group containing 5 to 13 carbon atoms, which is linear or branched;
R², R³ are, independently, hydrogen, methyl, ethyl or hydroxymethyl;
m, n are numbers from 0 to 12, with the proviso that m+n>4, and m+n<12 where
the different monomers can be arranged in statistical order, alternatingly or as a block copolymer, and
R⁴ is a methyl group.

3. The herbicide combination as claimed in claim 1, wherein
R¹ is a linear alkyl group
R¹ is an alkyl group with 5 to 11,
R², R³ are hydrogen, methyl or ethyl, and
m is a number from 0 to 5.

4. The herbicide combination as claimed in claim 1, wherein formula (I) m+n is >4.

5. The herbicide combination as claimed in claim 1, wherein formula (I) m is 0, and n is a number from >4.

6. The herbicide combination as claimed in claim 1, wherein
R¹ is a linear alkyl group with 7 to 9 carbon atoms;
m is 0;
n is a number from >4, and
R⁴ is a methyl group.

7. The herbicide combination as claimed in claim 1, where component (B) is selected from the group consisting of pyrimidinylsulfonylurea herbicides, amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, zuomihuanglong, triazinylsulfonylurea herbicides, chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron and mixtures thereof.

8. The herbicide combination as claimed in claim 1, where component (B) is selected from the group consisting of iodosulfuron-methyl, foramsulfuron, mesosulfuron-methyl, flazasulfuron, amidosulfuron, ethoxysulfuron thiencarbazone-methyl nicosulfuron and mixtures thereof.

9. The herbicide combination as claimed in claim 1, where component (B) is selected from the group consisting of iodosulfuron and nicosulfuron.

10. The herbicide combination as claimed in claim 1, where component (A) is pelargonic acid 6 EO ester methyl ether and component (B) is iodosulfuron.

11. The herbicide combination as claimed claim 1, where component (A) is pelargonic acid 6 EO ester methyl ether and component (B) is nicosulfuron.

12. The herbicide combination as claimed in claim 1, where component (A) is C₈/C₁₀ fatty acid 6 EO ester methyl ether and component (B) is iodosulfuron.

13. The herbicide combination as claimed in claim 1, where component (A) is pelargonic acid 6 EO ester methyl ether and component (B) is nicosulfuron.

14. A method for controlling unwanted vegetation wherein a herbicide combination comprising an effective amount of components (A) and (B), where (A) is one or more fatty acid derivatives of the formula (I), 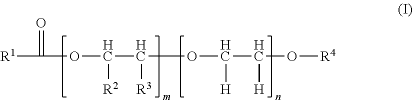
wherein
R¹ is an alkyl group containing 5 to 17 carbon atoms, which is linear or branched
R², R³ are, independently, hydrogen, methyl, ethyl or hydroxymethyl with the proviso that one of R² and R³ is hydrogen and the other is different from hydrogen
m, n are numbers from 0 to 17, with the proviso that m+n≥1, and m+n+p<18 where
the different monomers can be arranged in statistical order, alternatingly or as a block copolymer:
R⁴ is hydrogen or an alkyl group containing 1 to 10 carbon atoms, which is linear or branched,
and
(B) is one or more sulfonyl urea herbicides applied to the unwanted vegetation and/or its habitat.

15. (canceled)
